(19) United States
(12) Patent Application Publication
(10) Pub. No.: US 2006/0066442 A1
(43) Pub. Date: Mar. 30, 2006

(54) Smart keyless system control unit

(75) Inventor: Yasushi Hamada, Hiroshima (JP)

Correspondence Address: STAAS & HALSEY LLP, SUITE 700, 1201 NEW YORK AVENUE, N.W., WASHINGTON, DC, 20005, US

(73) Assignee: MAZDA MOTOR CORPORATION, Hiroshima (JP)

(21) Appl. No.: 11/199,205

(22) Filed: Aug. 9, 2005

(30) Foreign Application Priority Data
Sep. 30, 2004 (JP) 2004-288425

(51) Int. Cl. H04Q 5/22

(52) U.S. Cl. 340/10.1; 340/442

(57) ABSTRACT

When a predetermined condition is met while the engine is running (S1→yes), the output of an alternator is reduced (S2). Then, a request signal which requires a response from a portable unit is delivered in the vehicle and an ID signal output from the portable unit in response to the request signal is received. Based on the received signal, a judgment is made whether or not the particular portable unit is present in the vehicle (S3). If it is judged that the portable unit is not present in the vehicle (S4→no), an alarm is given (S5). By so doing, the influence of electromagnetic noise caused by surge noise of the alternator is avoided to allow detection of the portable unit in the vehicle with accuracy, thereby reducing the possibility of causing an erroneous alarm.

### TECHNICAL FIELD

The present invention relates to a smart keyless system control unit which permits doors to be locked/unlocked or an engine to start when an ID signal sent from a portable unit is authenticated.

### BACKGROUND ART

Japanese Unexamined Patent Publication No. 2003-269019 discloses a vehicular control system which permits doors to be locked/unlocked or an engine to start when an ID signal sent from a portable unit is authenticated. The portable unit functions as a common key. However, unlike the common key, there is no need to operate the portable unit by hand and a user is allowed to do various vehicle-related operations as long as he carries the portable unit in his pocket or bag. Such a control system is called smart keyless system.

In a vehicle which is not provided with the smart keyless system, a key must be inserted in a key cylinder or the like while the engine is running. Therefore, the key cannot be taken out of the vehicle while the engine is running. That is, until the engine stops, i.e., until a passenger who carries the key gets out of the vehicle, the key which permits the doors to be locked/unlocked or the engine to start will not be taken out of the vehicle. In a vehicle provided with the smart keyless system, on the other hand, there is no need to keep the key inserted. However, this advantage brings about various problems.

For example, the portable unit can be taken out of the vehicle even if the engine is running. If the portable unit has been taken out of the vehicle by a person other than the driver and the driver is not aware of the fact that the unit has been taken out, the driver cannot lock/unlock the doors or start the engine next time he needs to do so in the absence of the portable unit. Therefore, at least when the portable unit is taken out of the vehicle when the engine is running, the driver needs to be informed of it. As a possible example of a technique for that purpose, a request signal is sent from an on-vehicle device to the portable unit at a predetermined timing and a certain alarm is given when the portable unit does not send an ID signal in response to the request signal, or a received ID signal is not authenticated.

### PROBLEMS THAT THE INVENTION IS TO SOLVE

On the other hand, power supply harnesses which are arranged in a vehicle compartment or the vicinity of the vehicle compartment generate electromagnetic noise derived from surge noise of an alternator. When the portable unit is placed near the power supply harnesses, e.g., on a dashboard, the electromagnetic noise may become jamming to hinder the portable unit from receiving the request signal from the on-vehicle device. As a result, the on-vehicle device fails to recognize the presence of the portable unit and causes an erroneous alarm, though in fact the portable unit is present in the vehicle.

### DISCLOSURE OF THE INVENTION

The present invention has been achieved to solve the above-described problems. An object of the present invention is to avoid the influence of electromagnetic noise caused by surge noise of an alternator to allow detection of a portable unit present in a vehicle with accuracy, thereby reducing the possibility of causing erroneous alarms.

According to an aspect of the present invention, there is provided a control unit of a smart keyless system comprising an on-vehicle system mounted on a vehicle and a portable unit which are configured to achieve wireless communication, wherein
the on-vehicle system includes a sender which sends a request signal, a receiver which receives an ID signal sent by the portable unit which has received the request signal, and
a control means which commands the sender to send the request signal when a predetermined condition is met and controls at least one of door lock/unlock and engine start permission when the authentication of the ID signal received by the receiver succeeds,
the vehicle is provided with an alternator which generates an output at least when an engine is running and feeds the output to electrical components arranged in a vehicle compartment and/or near the vehicle compartment via a power supply harness and
the control means commands the sender to send the request signal at least when the engine is running and gives a predetermined alarm when the authentication of the ID signal received by the receiver does not succeed, and further includes a reduction control part which reduces the output of the alternator when the sender sends the request signal.

With this configuration, when the sender sends the request signal, the output of the alternator is reduced by the reduction control part. Therefore, the electromagnetic noise caused by the surge noise from the alternator is reduced. As a result, the request signal from the sender is not hindered by the electromagnetic noise and the portable unit properly receives the request signal. Thus, the possibility of causing erroneous alarms is reduced.

According to a suitable embodiment of the present invention, the control means commands the sender to send the request signal after a predetermined time has elapsed from when the output of the alternator was reduced. With this configuration, the request signal is sent after the surge noise of the alternator has been surely reduced. Therefore, the possibility of causing erroneous alarms is further reduced.

According to a suitable embodiment of the present invention, the control means commands the sender to send the request signal when a door of the vehicle is open and/or vehicle speed is not higher than a predetermined value and allows the reduction control part to reduce the output of the alternator at the time when the door is opened and/or the vehicle speed is reduced to not higher than the predetermined value. With this configuration, the alarm is not caused when the possibility that the key will be taken out of the vehicle is low, i.e., when the doors are closed or the vehicle speed is higher than the predetermined speed. Instead, the alarm is caused when the possibility that the key will be taken out of the vehicle is high, i.e., when any of the doors is opened or the vehicle speed is lower than the predetermined speed. Therefore, the output of the alternator is reduced at a suitable timing that allows detection of the portable unit present in the vehicle and prevention of the occurrence of the erroneous alarms with reliability.

According to a suitable embodiment of the present invention, the vehicle is provided with a battery which is charged by the output of the alternator and the reduction control part does not reduce the output of the alternator when the charged capacity of the battery is not higher than a predetermined level. With this configuration, the battery is prevented from going dead.

According to a suitable embodiment of the present invention, the reduction control part allows the output of the alternator to recover after the request signal has been sent by the sender and the rate of reducing the output of the alternator is higher than the rate of recovering the output of the alternator. With this configuration, the request signal is sent quickly, while a sudden drop of engine torque in recovering the output of the alternator is inhibited.

According to another aspect of the present invention, there is provided a control unit of a smart keyless system comprising an on-vehicle system mounted on a vehicle and a portable unit which are configured to achieve wireless communication, wherein
the on-vehicle system includes a sender which sends a request signal,
a receiver which receives an ID signal sent by the portable unit which has received the request signal, and
a CPU which commands the sender to send the request signal when a predetermined condition is met and controls at least one of door lock/unlock and engine start permission when the authentication of the ID signal received by the receiver succeeds,
the vehicle is provided with an alternator which generates an output at least when an engine is running and feeds the output to electrical components arranged in a vehicle compartment and/or near the vehicle compartment via a power supply harness, and
the CPU commands the sender to send the request signal at least when the engine is running and gives a predetermined alarm when the authentication of the ID signal received by the receiver does not succeed, and commands an alternator ECU to reduce the output of the alternator when the sender sends the request signal.

As described above, according to the present invention, the influence of the electromagnetic noise derived from the surge noise of the alternator is avoided to allow detection of the portable unit in the vehicle with accuracy, thereby reducing the possibility of the occurrence of erroneous alarms.

### BRIEF DESCRIPTION OF THE DRAWINGS

FIG. 1 is a view illustrating an in-vehicle arrangement of a smart keyless system to which an embodiment of a smart keyless control unit of the present invention is applied.

FIG. 2 is a block diagram illustrating the configuration of the smart keyless system.

FIG. 3 is a view illustrating communication areas of LF sender antennas according to the embodiment of the present invention.

FIG. 4 is a flow chart illustrating the operation of causing an alarm when a card key is taken outside the vehicle according to the embodiment of the present invention.

FIG. 5 is a flow chart illustrating the operation of reducing an output of an alternator according to the embodiment of the present invention.

FIG. 6 is a flow chart illustrating the operation of recovering the output of the alternator according to the embodiment of the present invention.

FIG. 7 is a view illustrating an example of a control circuit for the alternator.

FIG. 8 is a view illustrating how the alternator generates surge noise.

### BEST MODE FOR CARRYING OUT THE INVENTION

Hereinafter, with reference to the attached drawings, an explanation is given of a preferred embodiment of the present invention.

[Configuration of Smart Keyless System]

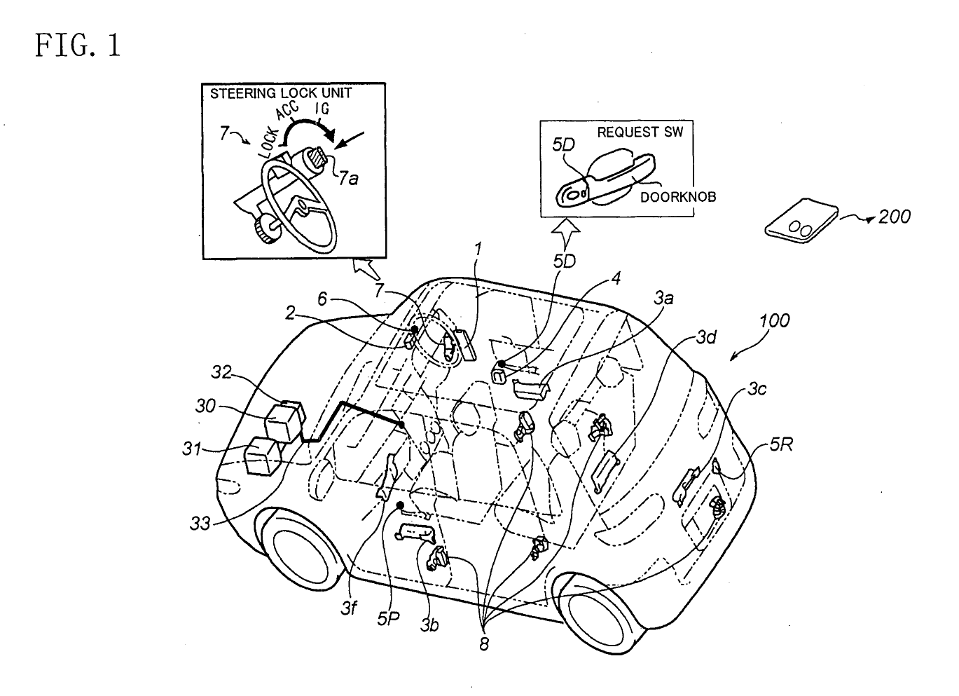

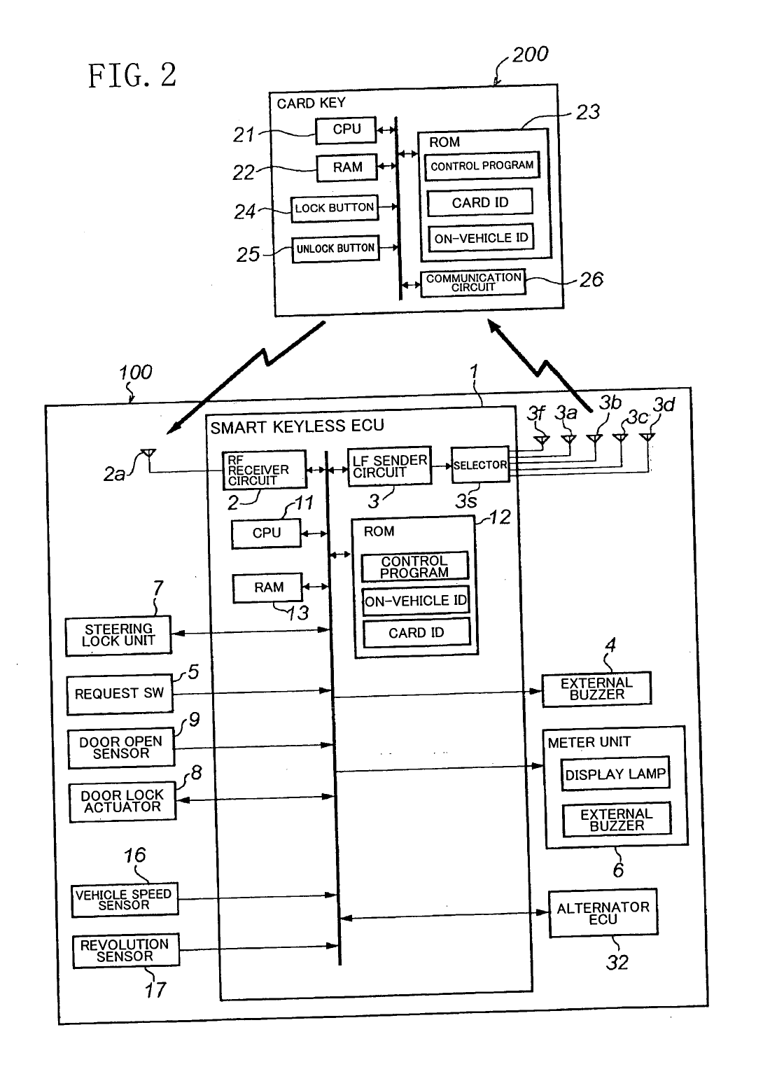

FIG. 1 shows an in-vehicle arrangement of a smart keyless system to which a smart keyless system control unit of the present invention is applied and FIG. 2 is a block diagram illustrating the configuration of the smart keyless system. As shown in the figures, the smart keyless system includes an on-vehicle system 100 which is mounted on a vehicle and a card key 200 as a portable unit to be carried by a user. The on-vehicle system 100 and the card key 200 are configured to establish communication by radio waves.

(Card Key)

The card key 200 includes, as specifically described in FIG. 2, a CPU 21 which is responsible for operations of the card key, a RAM 22 which provides a work area of the CPU 21, a ROM 23 which stores programs and data, a lock button 24 and an unlock button 25 operated by a user and a communication circuit 26 for communicating with the on-vehicle system 100. The ROM 23 stores, for example, control programs for realizing authentication communication with the on-vehicle system 100, ID information which is unique to the card key 200 (card ID) and ID information for identifying the on-vehicle system 100 (on-vehicle system ID). The CPU 21 loads a control program stored in the ROM 23 into the RAM 22 to execute it. For example, when the user presses the button (lock button 24 or unlock button 25) or an LF signal from the on-vehicle system 100 is received, the CPU 21 drives the communication circuit 26 to send an RF signal (e.g., UHF) as an ID signal containing the card ID to the on-vehicle system 100. The card key 200 is a card of about 80×50×4 mm, for example. Therefore, the user can easily carry the card key in his pocket or bag.

Now, an explanation is given of the configuration of the on-vehicle system 100.

(Smart Keyless Controller 1)

A smart keyless controller 1 serves as a smart keyless system control unit and is responsible for control of the smart keyless system. More specifically, as shown in FIG. 2, the smart keyless controller 1 is a smart keyless ECU. The smart keyless ECU includes a CPU 11, a ROM 12, a RAM 13, an RF receiver circuit 2 which receives RF signals via an RF receiver antenna 2a, a selector 3s which selects any of, for example, 5 LF sender antennas (3f, 3a, 3b, 3c and 3d) to be described later, and an LF sender circuit 3 which sends LF signals via the selector 3s. The ROM 12 stores control programs for realizing authentication communication with the card key 200 and controlling components described later, ID information unique to the on-vehicle system 100 (on-vehicle system ID) and ID information for identifying the card key 200 (card ID). The ROM 12 can register up to 6 ID cards. That is, though FIGS. 1 and 2 describe only a single card key 200, additional 5 card keys can be registered as available ones. However, in the following explanation, it is assumed that only a single card key 200 is registered and therefore the ROM 12 stores only a single card ID of the card key 200.

(LF Sender Antenna)

In this embodiment, 5 LF sender antennas (3f, 3a, 3b, 3c and 3d) are provided as described above. Provided are an in-vehicle front antenna 3f which is arranged at the front side of a vehicle compartment, a driver's seat antenna 3a (hereinafter abbreviated as D-seat antenna) which is arranged near the driver's seat, a passenger's seat antenna 3b (hereinafter abbreviated as P-seat antenna) which is arranged near the passenger's seat, a rear gate antenna 3c which is arranged near the rear gate and an in-vehicle rear antenna 3d which is arranged near the rear seat. By performing switching between these sender antennas, different communication areas (i.e., card key detection areas) are provided. The D-seat antenna 3a and the P-seat antenna 3b cover both an inside area and an outside area of the vehicle. The LF sender circuit 3 is operated in an external output mode or an internal output mode. Depending on the output mode, the communication areas of the D-seat antenna 3a and the P-seat antenna 3b are switched between the inside and outside areas.

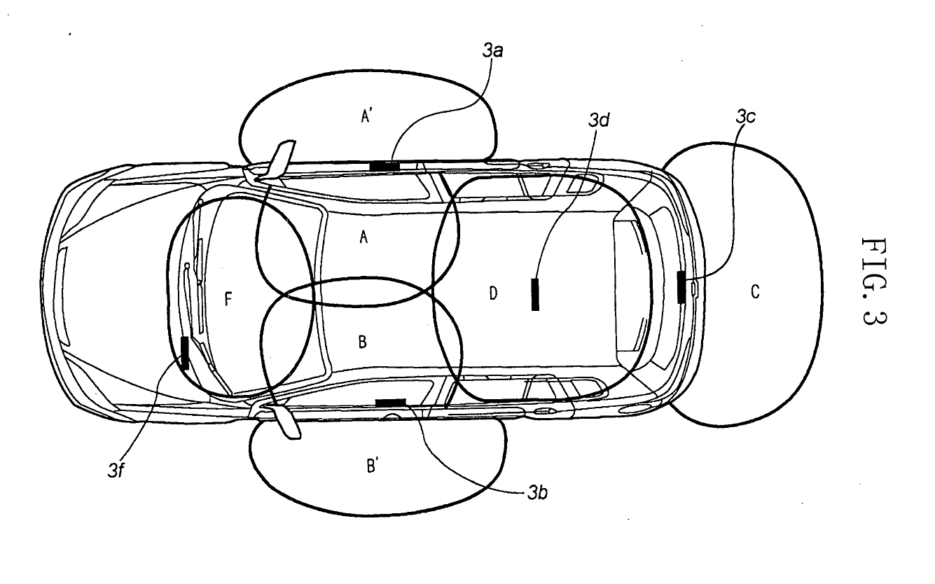

FIG. 3 illustrates the communication areas covered by the LF sender antennas. Regions F, A, B and D inside the vehicle are defined as communication areas covered by the in-vehicle front antenna 3f, D-seat antenna 3a, P-seat antenna 3b and in-vehicle rear antenna 3d, respectively. These four antennas cover all the regions of the vehicle compartment. An external region C behind the vehicle is covered by the rear gate antenna 3c. Further, external regions A′ and B′ are covered by the D-seat antenna 3a and the P-seat antenna 3b, respectively, when the LF sender circuit 3 is in the external output mode.

(External Buzzer)

An external buzzer 4 gives an alarm to the user outside the vehicle in response to a signal from the smart keyless controller 1.

(Request Switch)

Request switches (abbreviated as request SWs) are provided as a trigger for the operation of locking/unlocking the doors (including the rear gate, the same is applied hereinafter). FIG. 1 shows request SWs 5D, 5P and 5R. Each of the request SWs is arranged near a doorknob (outer handle) as shown in an enlarged view of 5D.

(Door Lock Actuator)

Door lock actuators 8 perform the operation of locking/unlocking the doors, respectively. As described below, when one of the request SWs is pressed, the door lock actuator 8 for the door corresponding to the pressed request SW is driven to lock/unlock the door.

(Meter Unit)

A meter unit 6 includes a vehicle speed meter, an engine revolution meter, a lamp and an internal buzzer for giving an alarm and allows the internal buzzer to beep or the lamp to come on/blink.

(Steering Lock Unit)

A steering lock unit 7 executes the operation of locking a key cylinder in response to a signal from the smart keyless controller 1. As shown in an enlarged view of the steering lock unit 7 in FIG. 1, the steering lock unit 7 includes an ignition knob 7a. The ignition knob 7a can be turned from the LOCK position to the accessory (ACC) position and to the ignition (IG) position. The ignition knob 7a is provided with a knob locking system which does not allow the ignition knob 7a to turn without permission of the smart keyless controller 1. Further, the ignition knob 7a is so configured that it can be pressed down at the LOCK position. The pressing of the knob 7a is recognized as an action requesting the knob locking system to unlock the knob 7a.

(Sensor)

Various sensors have been used in the vehicle. In this embodiment, a door open sensor 9 which senses that the doors are open, a vehicle speed sensor 16 which senses the vehicle speed and a revolution sensor 17 which senses the number of revolutions of the engine are provided.

(Alternator ECU)

As shown in FIG. 1, the vehicle of this embodiment includes a generator (hereinafter referred to as an alternator) 30 which generates electric power from the engine's mechanical energy and a battery 31 which is connected between the alternator 30 and an earth and charged by the output of the alternator 30. For example, the battery 31 is used as a power supply for an engine starter. Depending on output voltage of the battery 31 and the engine revolutions, an alternator ECU 32 (a generator ECU) controls exciting current of the alternator 30, thereby controlling the output of the alternator 30. The alternator ECU 32 is connected to the smart keyless controller 1 as shown in FIG. 2 and controls the exciting current of the alternator 30 in response to a control signal from the smart keyless controller 1.

Now, an explanation is given of the control operation by the alternator 30. That is, on what basis does the alternator 30 increase or decrease the current is described. In a control circuit shown in FIG. 7, a CPU 71 (CPU for the alternator ECU 32) switches the current of the alternator 30 between high and extremely low (almost 0). More specifically, when a current value of a current sensor 72 is higher than a predetermined reference value (various reference values are given depending on the switching), i.e., when the battery 31 is in a discharge state and/or a load 73 of electric components is high, the current of the alternator 30 is allowed to increase. On the other hand, when the current value sensed by the current sensor 72 is below the reference value, i.e., the battery 31 is in a discharge state and/or the load 73 of the electric components is low, the current of the alternator 30 is allowed to decrease.

Whether the current of the alternator 30 has been reduced or not is recognized by a control signal which is output from the CPU 71 to the alternator 30.

[Authentication Communication]

The smart keyless system of this embodiment is generally configured as described above. With this configuration, the smart keyless controller 1 achieves authentication communication with the card key 200.

The authentication communication includes, for example, first authentication for ID matching and second authentication of a challenge/response mode. In the first authentication, the smart keyless controller 1 selects one of the LF sender antennas 3f, 3a, 3b, 3c and 3d to send an LF signal containing the on-vehicle system ID stored in the ROM 12 as a request signal. The selection of the LF sender antenna is dependent on the function to be executed and defined as output patterns.

Upon receipt of the LF signal, the card key 200 extracts the on-vehicle device ID contained in the LF signal and checks whether the extracted on-vehicle device ID matches the on-vehicle device ID stored in the memory 23. When the IDs match, the card key 200 sends an RF signal as an ID signal containing the card ID and the on-vehicle system ID stored in the memory 23 through the communication circuit 26.

When the RF signal reaches the RF receiver circuit 2 through the RF receiver antenna 2a, the smart keyless controller 1 checks whether the card ID and the on-vehicle system ID contained in the RF signal match the card ID and the on-vehicle system ID stored in the ROM 12. At this point, the first authentication is completed.

When the first authentication has succeeded, the operation goes to the second authentication. First, the smart keyless controller 1 sends an LF signal containing an optional challenge data via the LF sender antenna which has been used in the first authentication.

Upon receipt of the LF signal, the card key 200 encrypts the challenge data contained in the LF signal using a private key K and sends an RF signal containing the encrypted data as a response data through the communication circuit 26.

When the RF signal reaches the RF receiver circuit 2 through the RF receiver antenna 2a, the smart keyless controller 1 decrypts the response data contained in the RF signal using the private key K and checks whether the decrypted data matches the original challenge data. When the data match, the authentication succeeds. On the other hand, when the data do not match, or the response from the card key to the LF signal sent in the first or second authentication is not obtained before time out (a certain period of time elapses), the authentication ends in failure.

In this manner, the authentication communication of this embodiment is carried out by the first authentication based on simple ID matching and the second authentication using encryption technology. By so doing, the card key becomes harder to counterfeit, thereby protecting the vehicle from theft. However, it should be understood that the above-described authentication communication is merely an example and other authentication technologies may also be applicable.

By making use of the above-described authentication communication, the presence of the registered particular card key (card key 200 in this embodiment) is checked. For example, checking whether the card key 200 is present in the vehicle or not (hereinafter referred to as in-vehicle authentication) is carried out in the following manner.

As described above, every region of the vehicle compartment is covered by the four antennas including the in-vehicle front antenna 3f, D-seat antenna 3a, P-seat antenna 3b and in-vehicle rear antenna 3d. Therefore, if an LF signal is sent to the antennas 3f, 3a, 3b and 3d in sequence and a response is given by any of the antennas, it is judged that the card key is at least present in the vehicle. Then, the above-described authentication communication is carried out with the antenna which responded first, whether the card key present in the vehicle is the registered one or not is judged. When the four antennas do not respond to the LF signal, it is judged that the card key is not present in the vehicle.

[Capabilities of the Smart Keyless System]

Capabilities which are exhibited by controlling the timing of the authentication communication and LF signal output patterns are explained below.

(Smart Entry)

When a user carrying the card key 200 presses the request SW provided on the door, the smart keyless controller 1 and the card key 200 communicate with each other to allow the door to lock/unlock. This is called smart entry. According to the conventional keyless entry system, the user has to take the key out and operate it by hand. However, the smart entry eliminates such a nuisance and the user can lock/unlock the door with the card key kept in his pocket or bag. The locking/unlocking operation of the door is carried out as a result of the following authentication communication.

Door Unlocking Operation

In unlocking the door, one of the request SWs 5D, 5P and 5R is pressed to be turned ON. At this time, the authentication communication is carried out to check whether the card key 200 is present outside the door corresponding to the pressed request SW. When the presence of the card key 200 is recognized, the door lock actuator 8 corresponding to the door is driven to unlock the door.

A condition for starting the authentication may be the following initiation condition 1.

[Initiation Condition 1]

The request SW corresponding to the locked door is turned from OFF to ON.

When the initiation condition 1 is met by turning the request SW 5D ON, for example, the smart keyless controller 1 switches the LF sender circuit 3 to the external output mode. Then, the D-seat antenna 3a is selected to send an LF signal to the communication area A′ (see FIG. 3) to implement the authentication communication. Likewise, where the request SW 5P is turned ON, the smart keyless controller 1 switches the LF sender circuit 3 to the external output mode. Then, the P-seat antenna 3b is selected to send an LF signal to the communication area B′ to implement the authentication communication. Further, where the request SW 5R is turned ON, the smart keyless controller 1 selects the rear gate antenna 3c to send an LF signal to the communication area C to implement the authentication communication.

Door Locking Operation

In locking the door, one of the request SWs 5D, 5P and 5R is pressed to be turned ON. At this time, the authentication communication is carried out to (1) check whether the card key 200 is present outside the door corresponding to the pressed request SW and (2) confirm the absence of the card key 200 from the vehicle compartment. When the presence of the card key outside the door and the absence of the card key from the vehicle compartment are recognized, the door lock actuator 8 corresponding to the door is driven to lock the door.

A condition for starting the authentication may be the following initiation condition 2.

[Initiation Condition 2]

The request SW corresponding to the unlocked door is turned from OFF to ON.

When the initiation condition 2 is met by turning the request SW 5D ON, for example, the smart keyless controller 1 switches the LF sender circuit 3 to the external output mode. Then, the D-seat antenna 3a is selected to send an LF signal to the communication area A′ (see FIG. 3) to implement the authentication communication. Likewise, where the request SW 5P is turned ON, the smart keyless controller 1 switches the LF sender circuit 3 to the external output mode. Then, the P-seat antenna 3b is selected to send an LF signal to the communication area B′ to implement the authentication communication. Further, where the request SW 5R is turned ON, the smart keyless controller 1 selects the rear gate antenna 3c to send an LF signal to the communication area C to implement the authentication communication.

The smart entry system according to this embodiment is as described above. In addition to this, the locking/unlocking of the door may be remote-controlled by operating the lock button 24 or the unlock button 25 of the card key 200 in the same manner as employed in the conventional keyless entry system.

[Smart Start]

Smart start is a capability that allows an engine to start as long as the card key 200 is present in the vehicle and eliminates the need of taking the key out and inserting it into the ignition keyhole. According to the smart start capability, after the presence of the card key 200 is confirmed as described above, the ignition knob 7a is unlocked to permit the engine to start.

The authentication for the smart start is carried out to check the presence of the card key 200 in the vehicle when the ignition knob 7a is set at the LOCK position (see FIG. 1). When the presence is confirmed, the ignition knob 7a is unlocked.

A condition for starting the authentication may be the following initiation condition 3.

[Initiation Condition 3]

The ACC is OFF and the IG is OFF (i.e., the ignition knob 7a is set at the LOCK position) and any of the following conditions is met:

(1) the ignition knob 7a is depressed;
(2) where the engine revolutions are less than 500 rpm and any of the closed doors is opened;
(3) where the engine revolutions are less than 500 rpm and every open door is closed; and
(4) the ACC and the IG are turned from ON to OFF.

When the initiation condition 3 is met, the above-described in-vehicle authentication is carried out. More specifically, an LF signal is sent from the in-vehicle front antenna 3f, D-seat antenna 3a, P-seat antenna 3b and in-vehicle rear antenna 3d in sequence and the LF sender antenna which received a response first is used for the authentication communication (antenna selection). Then, the authentication communication is implemented with the selected LF sender antenna.

If the authentication succeeds, the smart keyless controller 1 outputs an unlocking signal to the steering lock unit 7 to unlock the ignition knob 7a. By so doing, the ignition knob 7a is unlocked and the user is allowed to turn the ignition knob 7a from the LOCK position to the ACC position, and to the IG position to start the engine.

The in-vehicle authentication (antenna selection and authentication communication) is repeated every predetermined time until the following termination condition 1 is satisfied.

[Termination Condition 1]

Any of the following conditions is met:

(1) (the authentication has succeeded and) the ACC or the IG is turned ON; and
(2) the authentication has failed three times in a row when every door is closed and the ACC and the IG are OFF.

To save throughput, the predetermined time defined as an authentication cycle time may be varied between the case when the authentication fails and when the authentication succeeds. For example, the cycle time may be set to 1 second when the authentication has failed, whereas it is switched to 3 seconds when the authentication has succeeded).

(Capability of Giving an Alarm If the Card Key is Taken Out of the Vehicle)

The capability of giving an alarm if the card key is taken out of the vehicle is executed to give an alarm when the card key 200 is taken out of the vehicle in a particular situation such as when the engine is running. This capability prevents the occurrence of a situation where the user cannot restart the engine because the card key has been taken away.

In general, the card key is taken out of the vehicle in opening and closing the door. Therefore, the in-vehicle authentication is carried out when the door is opened or closed to confirm the presence of the card key 200 in the vehicle. Even if the doors are all closed, the card key may be taken out of the vehicle through the window. Therefore, it is necessary to continuously perform the in-vehicle authentication in the vehicle not only in opening and closing the door but also after the doors have been closed.

First, an explanation is given of the operation in opening the door. In this case, the initiation condition may be the following initiation condition 4.

[Initiation Condition 4]

The ACC or the IG is ON and any of the doors is opened.

When the initiation condition 4 is met, the in-vehicle authentication is carried out. More specifically, an LF signal is sequentially sent from the four antennas including the in-vehicle front antenna 3f, D-seat antenna 3a, P-seat antenna 3b and in-vehicle rear antenna 3d which cover every region of the vehicle compartment and the LF sender antenna which received a response first is used for the authentication communication (antenna selection). Then, the authentication communication is implemented with the selected LF sender antenna.

If the authentication has failed, the external buzzer 4 and/or the internal buzzer of the meter unit 6 is actuated to give an alarm. The alarm may be a simple beep or a chime but a voice message may also be given. The voice message may be, for example, “Card key has been taken outside. Please confirm.” In addition, a display lamp of the meter unit 6 may be allowed to blink.

The above-described in-vehicle authentication is carried out repeatedly every predetermined time until the following termination condition 2 is met. The alarm is continuously given until the authentication succeeds or the following termination condition 2 is satisfied.

[Termination Condition 2]

Any of the following conditions is met:

(1) the door in question is closed; and
(2) the ignition knob 7a is returned to the LOCK position;

To save throughput, the predetermined time defined as an authentication cycle time may be varied between the case when the authentication fails and when the authentication succeeds. For example, the cycle time may be set to 3 second when the authentication has failed, whereas it is switched to 5 seconds when the authentication has succeeded).

Next, an explanation is given of the operation in closing the door. In this case, the initiation condition may be the following initiation condition 5.

[Initiation Condition 5]

The following conditions are all met:

(1) the ignition knob 7a is not at the LOCK position;
(2) the vehicle speed is less than 5 km/h; and
(3) at least any of the doors which has been open is closed so that every door is closed.

When the initiation condition 5 is met, the in-vehicle authentication is carried out. More specifically, an LF signal is sequentially sent from the four antennas including the in-vehicle front antenna 3f, D-seat antenna 3a, P-seat antenna 3b and in-vehicle rear antenna 3d which cover every region of the vehicle compartment and the LF sender antenna which received a response first is used for the authentication communication (antenna selection). Then, the authentication communication is implemented with the selected LF sender antenna.

If the authentication fails, the external buzzer 4 and/or the internal buzzer of the meter unit 6 is actuated to give an alarm as described above for a predetermined time.

The above-described in-vehicle authentication is carried out repeatedly every predetermined time until the following termination condition 3 is met. In the same manner as in opening the door, the alarm is continuously given until the authentication succeeds or the following termination condition 3 is met.

[Termination Condition 3]

Any of the following conditions is met:

(1) any of the doors is opened;
(2) the ignition knob 7a is returned to the LOCK position; and
(3) the vehicle speed is 10 km/h or higher.

To save throughput, the predetermined time defined as an authentication cycle time may be varied between the case when the authentication fails and when the authentication succeeds. For example, the cycle time may be set to 5 second for 30 seconds after the authentication has failed, whereas it is set to 30 seconds in other time).

[Measures Against Electromagnetic Noise in Controlling the Alarm If the Card Key is Taken Out of the Vehicle]

The operation for giving the alarm indicating that the card key has been taken outside the vehicle is executed basically in the above-described manner. By the way, the vehicle is generally provided with electric components such as audio equipment and lights (current consumers). These are connected to the alternator 30 in parallel to the battery 31 so that power is fed from the alternator 30 or the battery 31 through the power supply harness 33. In general, a number of the power supply harnesses 33 are provided in various parts of the vehicle, including the vicinity of the dashboard as shown in FIG. 1 on which the card key is possibly placed.

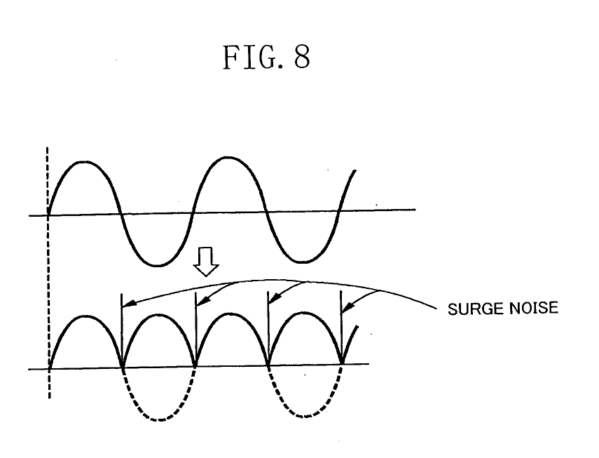

In general, the alternator 30 generates surge noise by the following mechanism. Since the alternator 30 is an alternating-current generator, it generates alternating voltage. However, since the battery 31 and the electric components mounted on the vehicle are ready for direct voltage, the alternating voltage needs to be rectified to direct voltage by a rectifier. As shown in FIG. 8, the surge noise is generated when the alternating current is switched to the direct current (commutation). This surge noise is called switching noise or commutation noise.

Since the alternator 30 generates the surge noise in this manner, the power supply harness 33 causes electromagnetic noise derived from the surge noise of the alternator 30. As mentioned above, the electromagnetic noise may cause jamming. Therefore, if the card key is placed near the power supply harness, the LF signal from the smart keyless controller 1 is hindered by the electromagnetic noise and the card key may fail to receive the request signal. In such a case, the smart keyless controller 1 may possibly fail to detect the presence of the card key 200 though in fact it is in the vehicle. As a result, an erroneous alarm may possibly be given.

Therefore, according to this embodiment, the alarming operation when the card key is taken out of the vehicle includes operation against the electromagnetic noise.

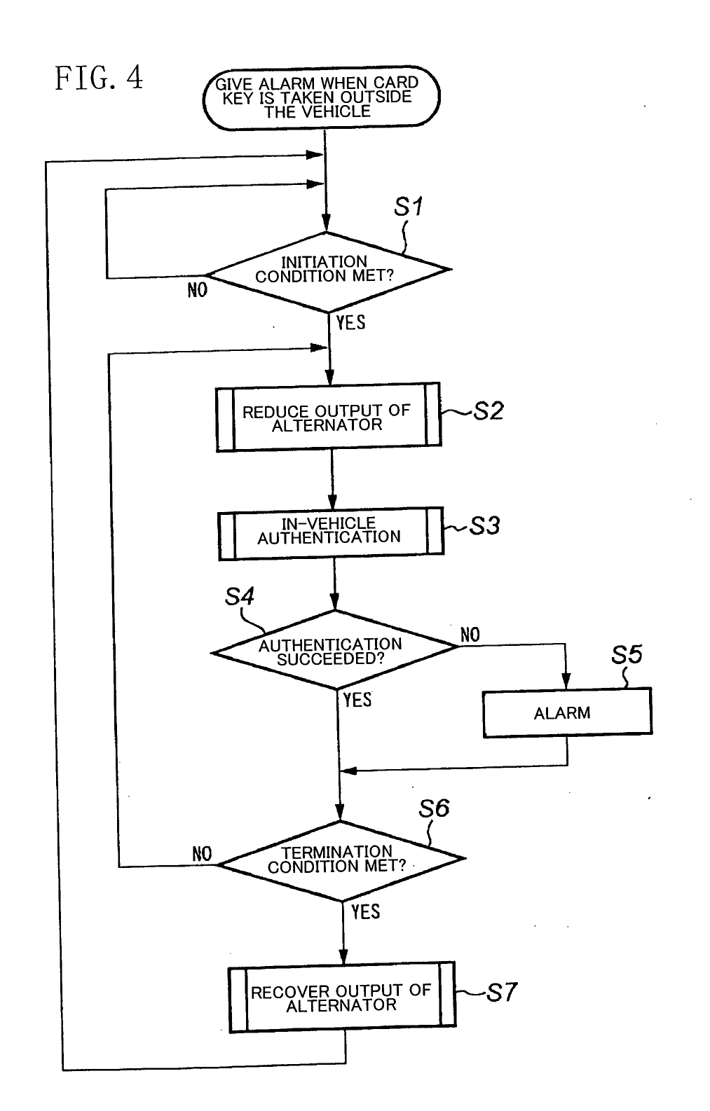

FIG. 4 is a flow chart illustrating the operation of giving the alarm when the card key is taken outside the vehicle executed by the smart keyless controller 1.

First, the smart keyless controller 1 monitors whether the above-described initiation condition 4 or 5 is met (step S1). When the initiation condition 4 or 5 is met, the output of the alternator 30 is reduced (step S2). Details of the reduction step are described later.

Then, the above-described in-vehicle authentication is carried out (step S3) and a judgment is made whether the authentication has succeeded or not (step S4). If the authentication has failed, the external buzzer 4 and/or the internal buzzer of the meter unit 6 gives an alarm for a predetermined time as described above (step S5). The alarm is continuously given until the authentication succeeds or the termination condition corresponding to the initiation condition met in step S1 (termination condition 2 or 3) is met.

Then, a judgment is made whether the termination condition is met (step S6). If the termination condition is not met, the operation returns to step S2 and after an elapse of a predetermined time, i.e., the authentication cycle time, the following operations are repeated again. When the termination condition is met, the output of the alternator 30 is recovered (step S7). Then, the operation returns to step S1 to repeat a series of steps.

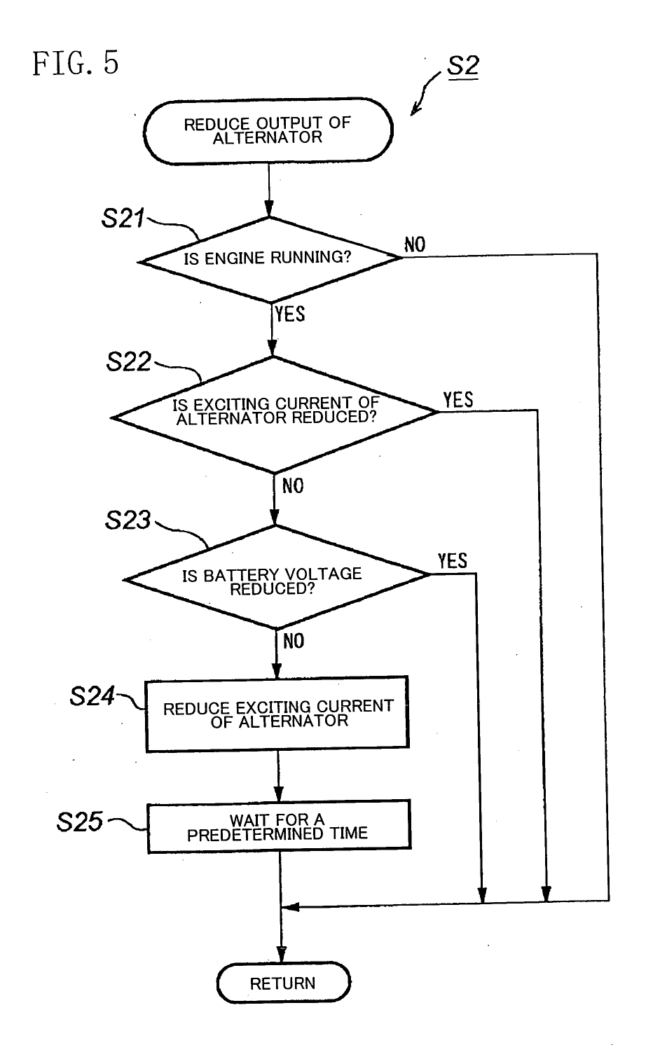

FIG. 5 is a flow chart illustrating how the output of the alternator is reduced in step S2.

First, a judgment is made whether the engine is running or not (step S21). More specifically, if the revolution sensor 17 senses that the engine revolutions are at 500 rpm or higher, it is judged that the engine is running. If the engine revolutions are less than 500 rpm, it is judged that the engine is stopped. When the engine is stopped, the reducing operation is cancelled because the alternator 30 does not generate the output.

If the engine is running, the operation goes to step S22. In other words, the step S22 and the following steps are carried out only when the initiation condition 4 or 5 is met in step S1 and it is recognized that the engine is running in step S21. For example, the condition that the engine is running and the initiation condition 4 are both met when it is sensed that the door is opened while the engine is running. The condition setting by combining step S1 and step S21 is merely an example and other conditions may be given. For example, instead of checking whether the initiation condition 4 or 5 is met, a decrease in vehicle speed below the predetermined speed (e.g., 10 km/h) when the engine is running may be considered as the condition for going to step S22.

In step S22, whether or not the present exciting current of the alternator 30 has been reduced is checked. If the exciting current has already been reduced, there is no need to reduce the exciting current of the alternator 30 any more. Therefore, the reducing operation is cancelled.

Then, preferably, the voltage value of the battery 31 is obtained from the alternator ECU 32 to check whether the value is lower than a predetermined value or not (step S32). By so doing, it is judged whether or not the charged capacity of the battery 31 is reduced below a predetermined level. If the output of the alternator 30 is reduced when the charged capacity has been reduced below the predetermined level, the battery 31 is not charged by the alternator 30, whereby the battery 31 may possibly become dead. Therefore, in such a case, the reducing operation does not proceed any more.

Where the conditions are met that the engine is running (S21), the exciting current of the alternator 30 is not lowered (S22) and the voltage value of the battery 31 is not lowered (S23), the exciting current is reduced (step S24) to decrease the output of the alternator 30. For example, the exciting current of the alternator 30 is reduced by one-half of that of the normal state. Or alternatively, the exciting current of the alternator 30 may be reduced to zero to stop the power generation. More specifically, in this step, the smart keyless controller 1 outputs a control signal for reducing the exciting current to the alternator ECU 32 and the alternator ECU 32 performs the operation of reducing the exciting current in response to the signal. The smart keyless controller 1 may be configured to include the function of the alternator ECU 32. In such a case, the smart keyless controller 1 directly controls the exciting current of the alternator 30.

Basically the operation is finished at this time. Preferably, this operation is finished after a predetermined time (e.g., 1 second) has elapsed (step S25) from when the exciting current was reduced in step S24. With this standby time, the operation smoothly goes to the in-vehicle authentication of step S3 after the surge noise of the alternator 30 has been surely reduced.

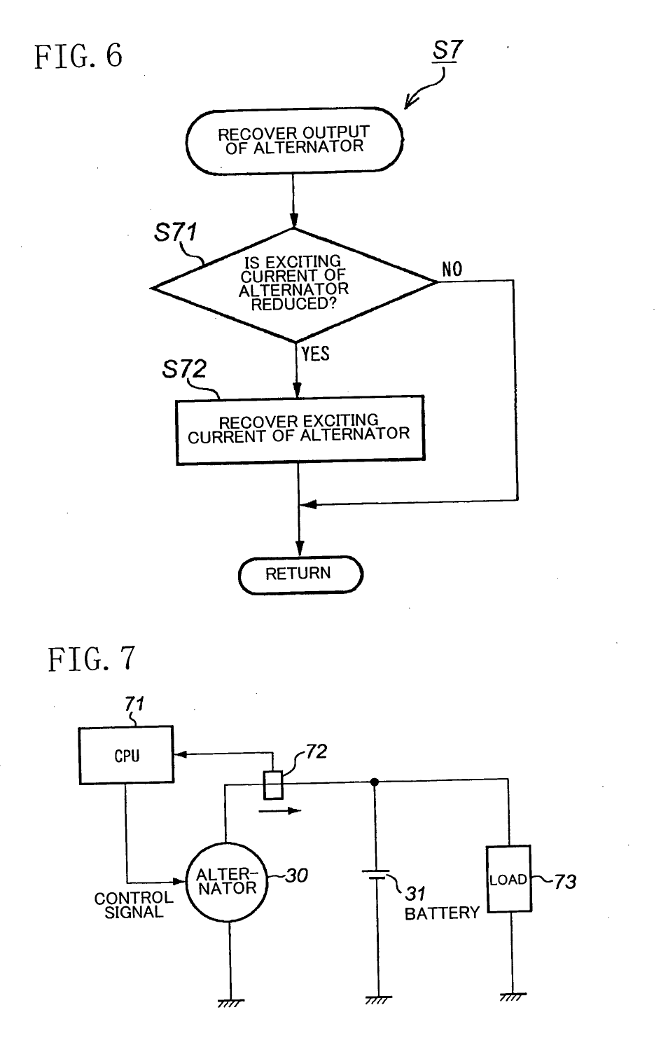

FIG. 6 is a flow chart illustrating how the operation of recovering the output of the alternator 30 is implemented in step S7.

First, a judgment is made whether or not the present exciting current of the alternator 30 has been reduced by the operation of reducing the output of the alternator 30 in step S2 (step S71). If the exciting current has not been reduced but is a normal value, the operation is cancelled. Where the exciting current has been reduced, the exciting current is recovered to a normal value (step S72).

The rate of reducing the exciting current of the alternator 30 in step S24 is preferably higher than the rate of recovering the reduced exciting current of the alternator 30 to the normal value. The faster the exciting current is reduced in step S24, the more quickly the in-vehicle authentication of step S3 is carried out, thereby causing an alarm soon if the card key is taken outside the vehicle (step S5). Further, in recovering the exciting current of the alternator 30, the engine torque suddenly drops and engine stall may possibly occur at worst. For these reasons, the recovering of the exciting current is preferably carried out slowly.

According to the capability of giving an alarm if the card key is taken out of the vehicle as described above, the output of the alternator 30 is reduced before the in-vehicle authentication of step S3, thereby reducing the electromagnetic noise derived from the surge noise of the alternator 30. As a result, the LF signal sent in the course of the in-vehicle authentication of step S3 is not hindered by the electromagnetic noise, preventing the occurrence of an erroneous alarm.

In the above description, the present invention has been explained in detail. The above-described embodiment is merely a preferable example of the present invention and it goes without saying that the configuration and the operations mentioned above may be modified in various ways.

What is claimed is:

1. A control unit of a smart keyless system comprising an on-vehicle system mounted on a vehicle and a portable unit which are configured to achieve wireless communication, wherein
the on-vehicle system includes
a sender which sends a request signal,
a receiver which receives an ID signal sent by the portable unit which has received the request signal, and
a control means which commands the sender to send the request signal when a predetermined condition is met and controls at least one of door lock/unlock and engine start permission when the authentication of the ID signal received by the receiver succeeds,
the vehicle is provided with an alternator which generates an output at least when an engine is running and feeds the output to electrical components arranged in a vehicle compartment and/or near the vehicle compartment via a power supply harness, and
the control means commands the sender to send the request signal at least when the engine is running and gives a predetermined alarm when the authentication of the ID signal received by the receiver does not succeed, and further includes a reduction control part which reduces the output of the alternator when the sender sends the request signal.

2. A control unit of a smart keyless system according to claim 1, wherein
the control means commands the sender to send the request signal after a predetermined time has elapsed from when the output of the alternator was reduced.

3. A control unit of a smart keyless system according to claim 1, wherein
the control means commands the sender to send the request signal when a door of the vehicle is open and/or vehicle speed is not higher than a predetermined value and allows the reduction control part to reduce the output of the alternator at the time when the door is opened and/or the vehicle speed is reduced to not higher than the predetermined value.

4. A smart keyless system control unit according to claim 1, wherein
the vehicle is provided with a battery which is charged by the output of the alternator and
the reduction control part does not reduce the output of the alternator when the charged capacity of the battery is not higher than a predetermined level.

5. A control unit of a smart keyless system according to claim 1, wherein
the reduction control part allows the output of the alternator to recover after the request signal has been sent by the sender and
the rate of reducing the output of the alternator is higher than the rate of recovering the output of the alternator.

6. A control unit of a smart keyless system comprising an on-vehicle system mounted on a vehicle and a portable unit which are configured to achieve wireless communication, wherein
the on-vehicle system includes
a sender which sends a request signal,
a receiver which receives an ID signal sent by the portable unit which has received the request signal, and
a CPU which commands the sender to send the request signal when a predetermined condition is met and controls at least one of door lock/unlock and engine start permission when the authentication of the ID signal received by the receiver succeeds,
the vehicle is provided with an alternator which generates an output at least when an engine is running and feeds the output to electrical components arranged in a vehicle compartment and/or near the vehicle compartment via a power supply harness, and
the CPU commands the sender to send the request signal at least when the engine is running and gives a predetermined alarm when the authentication of the ID signal received by the receiver does not succeed, and commands an alternator ECU to reduce the output of the alternator when the sender sends the request signal.
